(19) United States
(12) Patent Application Publication
(10) Pub. No.: US 2026/0232028 A1
(43) Pub. Date: Aug. 13, 2026

(54) SUSCEPTOR ASSEMBLY WITH FLUID CHANNELS FOR AN AEROSOL-GENERATING SYSTEM AND METHOD OF MANUFACTURE

(71) Applicant: Philip Morris Products S.A., Neuchatel (CH)

(72) Inventors: Onur DAYIOGLU, Neuchâtel (CH); Farhang MOHSENI, Neuchâtel (CH); Patrick Charles SILVESTRINI, Neuchâtel (CH)

(73) Assignee: Philip Morris Products S.A., Neuchatel (CH)

(21) Appl. No.: 19/156,479

(22) PCT Filed: Feb. 16, 2024
(86) PCT No.: PCT/EP2024/054029

§ 371 Date: Aug. 14, 2025

(30) Foreign Application Priority Data
Feb. 20, 2023 (EP) 23157574.7

(51) Int. Cl. A24F 40/465; A24F 40/10; A24F 40/42; A24F 40/485; A24F 40/70; H05B 6/10

(52) U.S. Cl. CPC A24F 40/465; A24F 40/10; A24F 40/42; A24F 40/485; A24F 40/70; H05B 6/108

(57) ABSTRACT

A susceptor assembly for an aerosol-generating system is provided, the susceptor assembly including: a susceptor element in the form of a sheet, and at least one channel formed on a surface of the sheet and configured to transport a liquid aerosol-forming substrate across the surface of the sheet; and a plurality of wires or wire sections arranged on the surface of the susceptor element, the at least one channel being formed between one or more of the wires or the wire sections.

The present disclosure relates to a susceptor assembly for an aerosol-generating system; a cartridge; an aerosol-generating device; and a method of manufacture for a susceptor assembly.

Aerosol-generating systems that employ inductive heating to generate inhalable aerosol from a liquid-aerosol-forming substrate are known in the art. Some aerosol-generating systems comprise a cartridge that is couplable to an aerosol-generating device that provides electrical power. A typical cartridge comprises an aerosol-forming substrate and a heater assembly. In a number of aerosol-generating systems the heating element is inductively heated, in which case the heating element is a susceptor element.

The inductive heating system typically includes a coil arranged around a susceptor element to which liquid aerosol-forming substrate is supplied. Alternating current flows through the coil, inducing eddy currents in the susceptor element, thereby heating the susceptor element.

The aerosol-forming substrate may be a liquid held in a liquid reservoir. A cartridge or device may comprise a wicking material that is in fluid communication with the liquid reservoir and is also in contact with the susceptor element. The wicking element is configured to draw aerosol-forming substrate from the liquid reservoir to the susceptor to be vapourised. An airflow passing over the susceptor element entrains the generated vapor. The entrained vapor cools and condenses to form an aerosol. This aerosol can then inhaled by a user.

It is also known in the art to use a susceptor in the form of a woven mesh made of ferritic stainless steel wires, which is heated in an alternating magnetic field. The woven mesh may provide some capillary action to draw liquid across the susceptor. A disadvantage of a woven susceptor is that it is fragile and can therefore be difficult to manufacture

It would be desirable to reduce the overall manufacturing complexity and cost by creating a susceptor assembly with fewer components and therefore a simpler design. It would also be desirable to provide a susceptor element that robust and easy to handle during manufacture.

In accordance with the first embodiment of the present disclosure, there is provided a susceptor assembly for an aerosol-generating system, the susceptor assembly comprising a susceptor element in the form of a sheet, and at least one channel formed in or on a surface of the sheet and configured to transport a liquid aerosol-forming substrate across the surface of the sheet.

Advantageously, having a susceptor assembly in which both heating and liquid transport is provided by a single component means that the manufacturing process can be simpler than prior susceptor assemblies. A susceptor that is a sheet, and in particular a non-woven sheet, that can be made more robust in comparison to a mesh, providing the same heating properties. A sheet susceptor with improved mechanical properties allows for easier handling during manufacturing.

The susceptor element may be substantially flat. Substantially flat may be defined as the susceptor element comprising both a width and a height much greater than a depth. The susceptor element may be substantially planar.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

As used herein, an “aerosol-generating system” means a system that generates an aerosol from one or more aerosol-forming substrates.

As used herein, the term “aerosol-forming substrate” refers to a substrate consisting of or comprising an aerosol-forming material that is capable of releasing volatile compounds upon heating to generate an aerosol.

As used herein, the term “liquid” refers to a substance provided in liquid form and encompasses substances provided in the form of a gel.

As used herein, a “susceptor element” means an element that is heatable by penetration with an alternating magnetic field. A susceptor element is typically heatable by at least one of Joule heating through induction of eddy currents in the susceptor element, and hysteresis losses. Suitable materials for the susceptor element include graphite, molybdenum, silicon carbide, stainless steels, niobium, aluminium and other conductive materials. Advantageously, the susceptor element may be formed of ferromagnetic material.

The susceptor assembly may comprise a plurality of channels. A plurality of channels may increase the flow of aerosol-forming substrate across the surface of the susceptor so more of the susceptor is wetted when compared to a single channel. If a larger portion of the susceptor element is wetted, increased vaporisation can occur. Aa plurality of channels also reduces the chance of areas of the susceptor becoming dry and overheat.

Preferably the plurality of channels are connected to one another. This allows the liquid aerosol-forming substrate to be widely and uniformly spread over a heating region of the susceptor element.

The plurality of channels may form a network of channels. Advantageously, this allows for an even distribution of liquid across the network.

The susceptor assembly may have at least one channel that extends from an edge of the susceptor element to a central region of the susceptor element. Advantageously, having channels that extend from the edge of the susceptor element to the centre reduces the likelihood of overheating as the liquid aerosol-forming substrate can flow to the centre of the susceptor element, which is more prone to overheating, and absorb heat.

The susceptor assembly may have a thickness and the plurality of channels may have a depth that is less than the thickness of the susceptor element. A channel with a thickness less than the thickness of the susceptor element may be more capable of retaining liquid aerosol-forming substrate than a channel that extends through the entire thickness of the susceptor element.

The susceptor assembly may comprise a plurality of wires or wire sections arranged on the surface of the susceptor element, the at least one channel being formed between the one or more wires or wire sections. Advantageously, manufacturing a susceptor assembly comprising wires to form at least one channel may be less complex than creating a susceptor assembly with channels formed in the surface of the susceptor element, particularly when the susceptor is a thin sheet.

The plurality of wires or wire sections may be arranged parallel to each other. Parallel channels may provide a uniform distribution of liquid aerosol-forming substrate across the surface of the susceptor element. Parallel, straight channels may also provide rapid transport of the liquid across the susceptor assembly.

The plurality of wires or wire sections may comprise an electrically conductive material. Wires that comprise a conductive material may contribute to the heating of the liquid-aerosol forming substrate In this way the overall efficiency of the susceptor assembly may be improved. The plurality of wires or wire sections may comprise a ferrous material.

The plurality of wires or wire sections may comprise at least one wire on or around the susceptor element. For example, the plurality of wires or wire sections may comprise at least one wire wound around the susceptor element, or the plurality of wires or wire sections may comprise at least one wire adhered to the susceptor element.

The at least one channel may be formed between successive windings of the wire.

The at least one channel may be formed between successive rows of adhered wire.

The process of providing the plurality of wires or wire sections on or around the susceptor element, by winding or adhering, may be simply achieved as part of a manufacturing process as only one wire may be necessary to create a plurality of channels.

The susceptor assembly may further comprise one or more apertures extending through the sheet from the surface to an opposite surface. Apertures that extend from one surface of the susceptor element to the opposite surface allow for the vapourised liquid to escape on either side of the susceptor assembly. Each of the one or more apertures may be connected to at least one channel.

The susceptor assembly may comprise a plurality of apertures, wherein the plurality of apertures have a size, shape or arrangement in a first region of the sheet that is different in a second region of the sheet. Advantageously, different sized apertures in different regions may allow for a more even distribution of evaporation across the surfaces of the susceptor element. The susceptor assembly may comprise a first region with a first density of apertures and a second region with a second density of apertures. A density of apertures may be defined as the number of apertures per unit area. In some embodiments the susceptor assembly comprises more than two regions of apertures with different densities. A configuration comprising smaller apertures with higher density may generate more heat compared to a configuration comprising larger apertures with a lower density. Adjusting the size of apertures in the first and second regions may be used to control how and where the heat is generated across susceptor element, and allow for designs of susceptor elements which can be optimized to reduce the risk of overheating of the susceptor element.

Each aperture of the plurality of apertures may be equal in size. A size of each of the apertures in the first region may be different from a size of each of the apertures in the second region. The size of each of the apertures in the first region may be less than the size of each of the apertures in the second region. A first mean size of the apertures in the first region may be less than a second mean size of the apertures in the second region. The size of each of the apertures may be a cross sectional area of each of the apertures parallel to the first side of the at least one susceptor element.

The first region may comprise a first regular array of apertures of the plurality of apertures. The first regular array of apertures may be a hexagonal array of apertures. The first regular array of apertures may be a square array of apertures. The second region may comprise a second regular array of apertures of the plurality of apertures. The second regular array of apertures may be a hexagonal array of apertures. The second regular array of apertures may be a square array of apertures. Advantageously, such regular arrays may allow for ease of manufacturing of both the first and second regions. Each aperture of the plurality of apertures may be circular in shape. Each aperture of the plurality of apertures may be rectangular or square in shape. Advantageously, such simple shapes may ease manufacturing, particularly with regards to stamping for example. The susceptor element may have a thickness. The thickness may be between 25 micrometres and 100 micrometres. Each aperture of the plurality of apertures may be formed via laser cutting. Each aperture of the plurality of apertures may be formed via chemical etching. Each aperture of the plurality of apertures may be formed via stamping or wire electrical discharge. Each of the plurality of apertures may be formed via laser engraving.

Each aperture of the plurality of apertures may extend by a first distance in a first direction parallel to the first and second sides of the susceptor element. Each aperture of the plurality of apertures may extend by a second distance in a second direction parallel to the first and second sides of the susceptor element and perpendicular to the first direction. The first distance may be greater than the second distance. The susceptor assembly may be configured to be heated by a magnetic field varying in a direction parallel to the first direction. The susceptor assembly may be configured to be arranged within a cartridge in an aerosol-generating system wherein the susceptor element may be heated by a magnetic field varying in a direction parallel to the first direction. Advantageously, it has been found that in such an arrangement extension of the apertures in the second direction perpendicular to the direction of the varying magnetic field does not contribute significantly to power and heat generation by induction. Therefore, it is beneficial to dispose the susceptor element such that the elongated direction of the apertures are aligned with the direction of the varying magnetic field.

A distance between the edge of an aperture and an edge of a proximate aperture may be between 0.05 mm and 0.5 mm. Preferably, the distance between the edge of an aperture and an edge of a proximate aperture may be between 0.1 and 0.4 mm. The apertures may be a hole, cut-up, or channel. The apertures may be defined through the a wicking layer. The apertures may have a circular cross-section. The apertures may have a diameter of at least 0.1 millimetres

The apertures may have a rectangular cross-section. The apertures may have a triangular cross-section. The apertures may have any suitable cross-section. The apertures may have a cross-sectional area of at least 0.005 millimetres squared. The apertures may have a cross-sectional area of at least 0.01 millimetres squared.

The susceptor sheet may comprise a non-woven structure. The susceptor sheet may comprise an etched foil. Wires that are wound around the foil may create small gaps, these small gaps may be used to create capillary action. The susceptor sheet may be folded so that at least one channel is positioned on an internal surface of the susceptor assembly. The susceptor sheet may comprise an elongate slot provided along the at least one fold line. Preferably the at least one fold line is parallel to direction in which the one or more wires are arranged. The susceptor sheet may be folded at the fold lines to form susceptor layers. The susceptor assembly may comprise at least one layer. Each susceptor layer may have a different arrangement or apertures. A susceptor layer may have more or less apertures than another susceptor layer. The susceptor assembly may comprise one or more middle layers, wherein the one or more middle layers have one or more susceptor layers on each side. The one or more middle layers may comprise a region without apertures.

The susceptor element may comprise a ferrous material. The susceptor element may comprise an annealed steel. Advantageously, annealed steel has increased ductility, allowing it to be shaped more easily than a hardened steel, or a steel that has not undergone heat treatment. Annealed steel also has increased toughness, allowing it to take more force before permanent deformation occurs. The susceptor element may comprise ferritic stainless steel. Due to its chemical make-up, ferritic stainless steels are relatively inexpensive in comparison to other varieties of stainless steels. Another advantage to a stainless steel is its resistance to corrosion, which is a desirable property for a susceptor element material.

The susceptor element may comprise at least one of graphite, molybdenum, silicon carbide, stainless steels, niobium and aluminium.

The susceptor assembly may comprise one or more ferromagnetic materials. Using ferromagnetic material is advantageous because of its magnetic properties, as it is utilised in the heating of the susceptor element.

Preferably, the susceptor element comprises AISI 430 stainless steel.

The susceptor element may have a relative magnetic permeability between 1 and 40000, when measured at a suitable frequency and temperature, for example when measured at frequencies up to 10 kHz at a temperature of 20 degrees Celsius. When a reliance on eddy currents for a majority of the heating is desirable, a lower permeability material may be used, and when hysteresis effects are desired then a higher permeability material may be used. Preferably, the material has a relative permeability between 500 and 40000 when measured at a suitable frequency and temperature, for example when measured at frequencies up to 10 kHz at a temperature of 20 degrees Celsius. This may provide for efficient heating of the susceptor element.

The susceptor element may be heatable by at least one of Joule heating through induction of eddy currents in the susceptor element and hysteresis loses.

In accordance with the second embodiment of the disclosure there is provided a cartridge for an aerosol-generating system. The cartridge may comprise a susceptor assembly according to the first embodiment and a liquid reservoir holding a liquid aerosol-forming substrate, wherein the channels are in fluid communication with the liquid aerosol-forming substrate in the liquid reservoir and is arranged to transport the liquid aerosol-forming substrate across the surface of the susceptor element by capillary action.

The cartridge may comprise liquid reservoir housing. The cartridge may comprise a retention material contained within the reservoir, the retention material for holding a liquid aerosol-forming substrate. The retention material may be a foam, a sponge, or a collection of fibres. The retention material may be formed from a polymer or a co-polymer. The retention material may be a spun polymer.

The susceptor element may be continuously wetted by the liquid aerosol-forming substrate contained in the reservoir by means of the wicking element which is in direct contact with both the liquid reservoir and susceptor element.

The cartridge may comprise an air inlet, an air outlet and an airflow path extending from the air inlet, past the susceptor element to the air outlet. Advantageously, this arrangement allows for air flow over the susceptor assembly when it is in use, so aerosolised liquid aerosol-forming substrate can continuously travel to the air outlet and to the user during a puff.

As used herein, the term “puff” is used to describe the action of a user drawing air through the aerosol-generating system by inhalation.

As used herein, the terms “air inlet’ and ‘air outlet” are used to describe one or more apertures through which air may be drawn into, and out of, respectively, of a component or portion of a component of the cartridge, aerosol-generating system or aerosol-generating device.

The cartridge may further comprise a susceptor holder that holds the susceptor assembly, wherein at least a portion of the airflow path is defined by the susceptor holder. The susceptor holder may have an elongate shape. The susceptor holder may be a tubular susceptor holder. The susceptor holder may be coupled to the susceptor assembly.

The susceptor holder may comprise a thermally insulative material. The susceptor holder may comprise an electrically insulative material. The susceptor holder may comprise at least one polymer. The susceptor holder may comprise polyether ether ketone (PEEK). The susceptor holder may be formed by injection moulding.

The susceptor holder may be positioned within the susceptor housing. The susceptor holder may support the susceptor assembly. The susceptor holder may be in contact with the susceptor element. The susceptor holder may retain the susceptor assembly so that the susceptor element is in direct fluid communication with the liquid aerosol-forming substrate in the liquid reservoir.

The susceptor holder may provide a liquid seal around the susceptor assembly to prevent escape of liquid aerosol-forming substrate from the liquid reservoir except through the at least one channel. The seal may prevent leakage of liquid from the cartridge allowing for a longer cartridge lifetime.

The susceptor holder may be configured to internally retain the susceptor assembly so that at least part of the susceptor element is positioned in the airflow path and such that the at least one channel is in fluid communication with the liquid aerosol-forming substrate. Advantageously, this arrangement will allow fluid to flow across the susceptor element as the one or more channels can draw fluid from the fluid reservoir through capillary action. At least one channel may extend from a periphery of the susceptor element positioned within the liquid reservoir to a central region of the susceptor element positioned in an airflow path through the cartridge. This will reduce the likelihood of overheating in the susceptor element as liquid aerosol-forming substrate is transferred to the central region and absorb heat.

The at least one channel may extend transverse to a direction of airflow in the airflow channel past the susceptor assembly. The direction of liquid feed from the liquid reservoir may be perpendicular to the direction of the airflow in the airflow channel past the susceptor assembly. The direction of liquid feed may be substantially perpendicular to the axis in which the plurality of wires are wound around the susceptor element.

Opposite ends of the susceptor element may be in fluid communication with the liquid reservoir. Advantageously, this may allow for increased capillary action and therefore wetting of the susceptor element.

Preferably, the cartridge comprises a mouthpiece, wherein the mouthpiece comprises the air outlet.

During use, air may enter the cartridge through the cartridge air inlet, flow through the airflow channel, across the susceptor assembly, and exit the cartridge through the air outlet defined by the mouthpiece. Vaporised liquid aerosol-forming substrate generated by the susceptor assembly may be entrained in the airflow in the airflow channel. The entrained vapor condenses to form an aerosol for inhalation by a user as the aerosol exits the cartridge through the air outlet defined by the mouthpiece.

The cartridge may comprise at least one seal extending across a portion of the airflow channel. The cartridge may comprise an upstream seal extending across the cartridge air inlet. The upstream seal may be sealed to the holder. The upstream seal may be sealed to the cartridge outer housing. The upstream seal may be sealed to both the holder and the cartridge outer housing. The upstream seal may be frangible or removable. The upstream seal may be arranged to be automatically ruptured upon insertion of the cartridge into an aerosol-generating device.

The cartridge may comprise a downstream seal. The downstream seal may extend across the air outlet defined by the mouthpiece. The downstream seal may be sealed to the mouthpiece. The downstream seal may be frangible or removable.

In embodiments in which the cartridge comprises a cartridge outer housing, the mouthpiece may be formed integrally with the cartridge outer housing. The mouthpiece may be formed separately from the cartridge outer housing and connected to the cartridge outer housing. The mouthpiece may be connected to the cartridge outer housing by an interference fit.

In embodiments in which the cartridge comprises a mouthpiece, a cartridge outer housing, or both a mouthpiece and a cartridge outer housing, each of the mouthpiece and the cartridge outer housing may be formed from any suitable material or combination of materials. Preferably, the mouthpiece and the cartridge outer housing are formed from a plastic or thermoplastic that is suitable for food or pharmaceutical applications. For example, each of the mouthpiece and the cartridge outer housing may comprise at least one of polypropylene, polyetheretherketone (PEEK) and polyethylene. The material is preferably light and non-brittle.

According to a third aspect of the present disclosure, there is provided an aerosol-generating system. The aerosol-generating system may comprise a cartridge according to the second aspect of the disclosure and an aerosol-generating device. The aerosol-generating device may comprise an inductor coil and a power supply connected to the inductor coil and configured to provide an alternating current to the inductor coil to generate an alternating magnetic field. The cartridge and aerosol-generating device may be configured to connect with one another such that the susceptor assembly is positioned within the alternating magnetic field. Advantageously, less power is required to heat the susceptor element in this arrangement compared to the susceptor being placed elsewhere in the system.

The aerosol-generating system may comprise control circuitry, wherein the control circuitry is connected to the inductor coil, and configured to control power delivery to the inductor coil. The control circuitry may comprise a sensor for detecting when a user puffs on the aerosol-generating system. The sensor may be configured to be in fluid communication with the device airflow passage when the cartridge is coupled to the aerosol-generating device. The control circuitry may be configured to detect when a user is puffing on the system based on a signal from the sensor. The sensor may be an airflow sensor. The sensor may be a pressure sensor. The sensor may allow the aerosol-generating system to supply power on a puff-by-puff basis.

The control circuitry may be configured to supply power to the inductor coil continuously following activation of the system or may be configured to supply power intermittently, such as on a puff-by-puff basis. The power may be supplied to the inductive heating assembly in the form of pulses of electrical current, for example, by means of pulse width modulation (PWM). The control circuitry may comprise DC/AC inverter, which may comprise a Class-D or Class-E power amplifier. The control circuitry may comprise further electronic components. For example, in some embodiments, the control circuitry may comprise any of: sensors, switches, display elements.

The inductor coil may be a helical coil, wherein at least a portion of the helical coil circumscribes the susceptor assembly when the aerosol-generating device and cartridge are connected to one another. The helical coil may have a circular cross section when viewed parallel to the longitudinal axis of the aerosol-generating system. The inductor coil may comprise one or more coils.

The magnetic field generated by the inductor may be parallel to the longitudinal axis of the airflow passage. The susceptor assembly may be configured to be arranged within the cartridge such that the susceptor element may be heated by a magnetic field varying in a direction parallel to the first direction.

Advantageously, it has been found that in such an arrangement, extension of the apertures in the second direction perpendicular to the direction of the varying magnetic field does not contribute significantly to power and heat generation by induction. Therefore, it is beneficial to dispose the susceptor element such that a largest dimension of the apertures is aligned with the direction of the varying magnetic field.

The aerosol-generating system may be a handheld aerosol-generating system configured to allow a user to puff on the mouthpiece to draw an aerosol through the system air outlet. The aerosol-generating system may have a size comparable to a conventional cigar or cigarette. The aerosol-generating system may have a total length between about 30 millimetres and about 150 millimetres. The aerosol-generating system may have an external diameter between about 5 millimetres and about 30 millimetres. The aerosol-generating system may be an electrically operated smoking system.

According to a fourth aspect of the present disclosure, there is provided an aerosol-generating system. The aerosol-generating system may comprise a susceptor assembly according to the first aspect of the present disclosure and a liquid reservoir holding a liquid aerosol-forming substrate, wherein the channels are in fluid communication with the liquid aerosol-forming substrate in the liquid reservoir and is arranged to transport the liquid aerosol-forming substrate across the surface of the susceptor element by capillary action. The aerosol generating system may comprise an inductor coil and a power supply, connected to the inductor coil and configured to provide an alternating current to the inductor coil to generate an alternating magnetic field, wherein the susceptor assembly is positioned within the alternating magnetic field.

The aerosol-generating system may comprise control circuitry. The control circuitry may comprise a sensor for detecting when a user puffs on the aerosol-generating system. The sensor may be configured to be in fluid communication with the device airflow passage. The control circuitry may be configured to detect when a user is puffing on the system based on a signal from the sensor. The sensor may be an airflow sensor. The sensor may be a pressure sensor. The sensor may allow the aerosol-generating system to supply power on a puff-by-puff basis.

The control circuitry may be configured to supply power to the inductor coil continuously following activation of the device or may be configured to supply power intermittently, such as on a puff-by-puff basis. The power may be supplied to the inductive heating assembly in the form of pulses of electrical current, for example, by means of pulse width modulation (PWM). The control circuitry may comprise DC/AC inverter, which may comprise a Class-D or Class-E power amplifier. The control circuitry may comprise further electronic components. For example, in some embodiments, the control circuitry may comprise any of: sensors, switches, display elements.

The inductor coil may be a helical coil, wherein at least a portion of the helical coil circumscribes the susceptor assembly. The helical coil may have a circular cross section when viewed parallel to the longitudinal axis of the aerosol-generating device.

The aerosol-generating system may further comprise an air inlet, an air outlet and an airflow path extending from the air inlet, past the susceptor assembly. The airflow path may be perpendicular to the direction of the liquid feed from the liquid reservoir.

The aerosol-generating system may comprise a susceptor holder that holds the susceptor assembly, wherein at least a portion of the airflow path is defined by the susceptor holder. This is advantageous because vapourised aerosol-forming substrate leaving the susceptor assembly immediately mixes in the air of the airflow path to be inhaled by the user.

The susceptor holder may provide a liquid seal around the susceptor assembly to prevent escape of liquid aerosol-forming substrate from the liquid reservoir except through the at least one wicking layer.

The at least one channel of the susceptor assembly may extend transverse to a direction of airflow in the airflow channel past the susceptor assembly. The direction of liquid feed from the liquid reservoir may be perpendicular to the direction of the airflow in the airflow channel past the susceptor assembly. The direction of liquid feed may be substantially perpendicular to the axis in which the plurality of wires are wound around the susceptor element.

Opposite ends of the susceptor element may be in fluid communication with the liquid reservoir. Advantageously, this may allow for increased capillary action and therefore wetting of the susceptor element.

The aerosol-generating system may comprise a mouthpiece. The aerosol-generating system may comprise a mouthpiece. The aerosol-generating system may be a handheld aerosol-generating system configured to allow a user to puff on the mouthpiece to draw an aerosol through the device air outlet. The aerosol-generating system may have a size comparable to a conventional cigar or cigarette. The aerosol-generating system may have a total length between about 30 millimetres and about 150 millimetres. The aerosol-generating device may have an external diameter between about 5 millimetres and about 30 millimetres.

In all aspects of the present disclosure, the liquid aerosol-forming substrate may comprise volatile compounds that may form an aerosol. Volatile compounds may be released by heating the aerosol-forming substrate. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di-or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours.

The liquid aerosol-forming substrate may comprise nicotine and at least one aerosol former. The aerosol former may be glycerine or propylene glycol. The aerosol former may comprise both glycerine and propylene glycol. The liquid aerosol-forming substrate may have a nicotine concentration of between about 0.5% and about 10%, for example about 2%.

In all aspects of the present disclosure, the power supply may be a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences of the aerosol-generating system; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the susceptor assembly.

In accordance with a further aspect of the present disclosure, there is provided a method of manufacturing an aerosol-generating device comprising steps of:
providing a sheet of material capable of being heatable through induction of eddy currents and hysteresis losses to vaporise an aerosol-forming substrate; and
forming channels in the sheet of material to a width and depth wherein the channels are capable of transporting liquid across the surface of the sheet through capillary action.

Forming the channels may be by etching or laser engraving, for example.

In accordance with a further aspect of the present disclosure, there is provided a method of manufacturing an aerosol-generating device comprising steps of:
providing a sheet of material capable of being heatable through induction of eddy currents and hysteresis losses to vaporise an aerosol-forming substrate; and
providing one or more wires on or around the sheet of material to provide capillary channels on a surface of the sheet of material between portions of the one or more wires, wherein the channels are capable of transporting liquid across the surface of the sheet through capillary action.

The providing of the one or more wires may be by winding wires around the sheet of material or by adhering wires on the sheet of material, for example.

The invention is defined in the claims. However, below there is provided a non-exhaustive list of non-limiting examples. Any one or more of the features of these examples may be combined with any one or more features of another example, embodiment, or aspect described herein.

Example Ex1: A susceptor assembly for an aerosol-generating system, the susceptor assembly comprising:
a susceptor element in the form of a sheet, and at least one channel formed in or on a surface of the sheet and configured to transport a liquid aerosol-forming substrate across the surface of the sheet.

Example Ex2: A susceptor assembly according to example Ex1, wherein the at least one channel is formed in the surface of the susceptor element.

Example Ex3: A susceptor assembly according to example Ex1 or Ex2, comprising a plurality of channels configured to transport a liquid aerosol-forming substrate across the surface of the sheet.

Example Ex4: A susceptor assembly according to example Ex3, wherein the plurality of channels are connected to one another.

Example Ex5: A susceptor assembly according to example Ex3 or Ex4, wherein the plurality of channels form a network of channels.

Example Ex6: A susceptor assembly according to any one of examples Ex3 to Ex5, wherein the at least one channel extends from an edge of the susceptor element to a central region of the susceptor element.

Example Ex7: A susceptor assembly according to any one of the preceding examples, wherein the susceptor element has a thickness and the channels have a depth that is less than the thickness of the susceptor element.

Example Ex8: A susceptor assembly according to any one of the preceding examples, comprising a plurality of wires or wire sections arranged on the surface of the susceptor element, the at least one channel being formed between the plurality of wires or wire sections.

Example Ex9: A susceptor assembly according to Example Ex8, comprising a plurality of wires or wire sections arranged parallel to each other.

Example Ex10: A susceptor assembly according to Example Ex8 or Ex9, wherein the plurality of wires or wire sections comprise an electrically conductive material.

Example Ex11: A susceptor assembly according to Example Ex8, Ex9 or Ex10, wherein the plurality of wires or wire sections comprise a ferrous material

Example Ex12: A susceptor assembly according to any one of example Ex8 to Ex11, wherein the plurality of wires or wire sections comprises at least one wire wound around the susceptor element.

Example Ex13: A susceptor assembly according to example Ex12, wherein the at least one channel is formed between successive windings of the wire.

Example Ex14: A susceptor assembly according to any one of the preceding examples, further comprising one or more apertures extending through the sheet from the surface to an opposite surface.

Example Ex15: A susceptor assembly according to examples Ex16, wherein each of the one or more apertures is connected to at least one channel.

Example Ex16: A susceptor assembly according to example Ex16 or Ex17, wherein the one or more apertures comprises a plurality of apertures, and wherein the plurality of apertures have a size, shape or arrangement in a first region of the sheet that is different than in a second region of the sheet.

Example Ex17: A susceptor assembly according to any one of the preceding examples, wherein the sheet comprises a non-woven structure.

Example Ex18: A susceptor assembly according to any one of the preceding examples, wherein the sheet comprises an etched foil.

Example Ex19: A susceptor assembly according to any one of the preceding examples, wherein the sheet is folded along at least one fold line to provide a plurality of layers of the susceptor element.

Example Ex20: A susceptor assembly according to example Ex21, wherein the sheet is folded so that the at least one channel is positioned on an internal surface of the susceptor assembly.

Example Ex21: A susceptor assembly according to example Ex21 or Ex22, wherein the sheet comprises an elongate slot provided along the at least one fold line.

Example Ex22: A susceptor assembly according to any preceding example, wherein the susceptor element comprises a perforated foil strip.

Example Ex23: A susceptor assembly according to any one of the preceding examples, wherein the susceptor element comprises ferrous material.

Example Ex24: A susceptor assembly according to any one of the preceding examples, wherein the susceptor element comprises ferritic stainless steels.

Example Ex25: A susceptor assembly according to any one of the preceding examples, wherein the at least one susceptor element is heatable by at least one of Joule heating through induction of eddy currents in the susceptor element, and hysteresis losses.

Example Ex26: A susceptor assembly according to any one of the preceding examples, wherein the at least one susceptor element comprises at least one of graphite, molybdenum, silicon carbide, stainless steels, niobium and aluminium.

Example Ex27: A susceptor assembly according to any one of the preceding examples, wherein the at least one susceptor element comprises at least one ferromagnetic material.

Example Ex28: A susceptor assembly according to any one of the preceding examples, wherein the at least one susceptor element comprises AISI 430 stainless steel.

Example Ex29: A susceptor assembly according to any one of the preceding examples, wherein the at least one susceptor element has a relative permeability between 1 and 40000, when measured at frequencies up to 10 kHz at a temperature of 20 degrees Celsius.

Example Ex30: A susceptor assembly according to any one of the preceding examples wherein the at least one susceptor element has a relative permeability between 500 and 40000, when measured at frequencies up to 10 kHz at a temperature of 20 degrees Celsius

Example Ex31: A cartridge for an aerosol-generating system, the cartridge comprising:
a susceptor assembly according to any preceding example; and
a liquid reservoir holding a liquid aerosol-forming substrate, wherein the channels are in fluid communication with the liquid aerosol-forming substrate in the liquid reservoir and is arranged to transport the liquid aerosol-forming substrate across the surface of the susceptor element by capillary action.

Example Ex32: A cartridge according to example Ex31, further comprising an air inlet, an air outlet and an airflow path extending from the air inlet, past the susceptor element to the air outlet.

Example Ex33: A cartridge according to example Ex32, further comprising a susceptor holder that holds the susceptor assembly, wherein at least a portion of the airflow path is defined by the susceptor holder.

Example Ex34: A cartridge according to example Ex33, wherein the susceptor holder retains the susceptor assembly so that at least a part of the susceptor element is positioned in the airflow path and such that the at least one channel is in fluid communication with the liquid aerosol-forming substrate in the liquid reservoir.

Example Ex35: A cartridge according to example Ex33 or Ex34, wherein the susceptor holder provide a liquid seal around the susceptor assembly to prevent escape of liquid aerosol-forming substrate from the liquid reservoir except through the at least one channel.

Example Ex36: A cartridge according to example Ex 34 or EX35, wherein the at least one channel extends from a periphery of the susceptor element positioned within the liquid reservoir to a central region of the susceptor element positioned in an airflow path through the cartridge.

Example Ex37: A cartridge according to any one of examples Ex34 to Ex36, wherein the at least one channel extends transverse to a direction of airflow past the susceptor element.

Example Ex38: A cartridge according to any one of examples Ex31 to Ex37, wherein opposite ends of the susceptor element are in communication with reservoir.

Example Ex39: A cartridge according to any one of examples Ex31 to Ex38, further comprising a mouthpiece, wherein the mouthpiece comprises the air outlet.

Example Ex40: An aerosol-generating system comprising:
a cartridge according to any one of examples Ex 32 to Ex39; and
an aerosol-generating device, the aerosol-generating device comprising: an inductor coil;
a power supply connected to the inductor coil and configured to provide an alternating current to the inductor coil to generate an alternating magnetic field; wherein the cartridge and aerosol-generating device are configured to connect with one another such that the susceptor assembly is positioned within the alternating magnetic field.

Example Ex41: An aerosol-generating system according to Ex40, further comprising control circuitry, wherein the control circuitry is connected to the inductor coil, and configured to control power delivery to the inductor coil.

Example Ex42: An aerosol-generating system according to examples Ex41 or Ex42, wherein the inductor coil is a helical coil positioned around the susceptor assembly when the aerosol-generating device and the cartridge are connected to one another.

Example Ex43: An aerosol-generating system comprising:
a susceptor assembly according to any one of examples Ex1 to Ex30;
a liquid reservoir holding a liquid aerosol-forming substrate, wherein the channels are in fluid communication with the liquid aerosol-forming substrate in the liquid reservoir and is arranged to transport the liquid aerosol-forming substrate across the surface of the susceptor element by capillary action;
an inductor coil; and
a power supply, connected to the inductor coil and configured to provide an alternating current to the inductor coil to generate an alternating magnetic field; wherein the susceptor assembly is positioned within the alternating magnetic field.

Example Ex44: An aerosol-generating system according to Ex43, further comprising control circuitry, wherein the control circuitry is connected to the inductor coil and is configured to control power delivery to the inductor coil.

Example Ex45: An aerosol-generating system according to example Ex44, wherein the control circuitry comprises a sensor, and is configured such that on detection of a puff by the sensor the control circuitry delivers power from the power supply to the coil.

Example Ex46: An aerosol-generating system according to any one of examples Ex43 to Ex45, wherein the inductor coil is a helical coil positioned around the susceptor element.

Example Ex47: An aerosol-generating system according to any one of examples Ex43 to Ex46, further comprising an air inlet, an air outlet and an airflow path extending from the air inlet, past the susceptor element to the air outlet.

Example Ex48: An aerosol-generating system according to example Ex47, further comprising a susceptor holder that holds the susceptor assembly, wherein at least a portion of the airflow path is defined by the susceptor holder.

Example Ex49: An aerosol-generating system according to example Ex48, wherein the susceptor holder retains the susceptor assembly so that at least a part of the susceptor element is positioned in the airflow path and such that the at least one channel is in fluid communication with the liquid aerosol-forming substrate in the liquid reservoir.

Example Ex50: An aerosol-generating system according to example Ex49, wherein the susceptor holder provides a liquid seal around the susceptor assembly to prevent escape of liquid aerosol-forming substrate from the liquid reservoir except through the at least one channel.

Example Ex51: An aerosol-generating system according to example Ex49 or Ex50, wherein the at least one channel extends from a periphery of the susceptor element positioned within the liquid reservoir to a central region of the susceptor element positioned in an airflow path through the cartridge.

Example Ex52: An aerosol-generating system according to any one of examples Ex49 to Ex51, wherein the at least one channel extends transverse to a direction of airflow past the susceptor element.

Example Ex53: An aerosol-generating system according to any one of examples Ex43 to Ex52, wherein opposite ends of the susceptor element are in communication with reservoir.

Example Ex54: An aerosol-generating system according to any one of examples Ex44 to Ex53, further comprising a mouthpiece, wherein the mouthpiece comprises the air outlet.

Example Ex55: A method of manufacturing a susceptor assembly for an aerosol-generating device, the method comprising:
providing a sheet of material capable of being heatable through induction of eddy currents and hysteresis losses to vaporise an aerosol-forming substrate; and
forming channels, for example by etching or laser engraving, in the sheet of material to a width and depth wherein the channels are capable of transporting liquid across the surface of the sheet through capillary action.

Example Ex56: A method of manufacturing a susceptor assembly for an aerosol-generating device, the method comprising:
providing a sheet of material capable of being heatable through induction of eddy currents and hysteresis losses to vaporise an aerosol-forming substrate; and
providing one or more wires on or around the sheet of material, for example by winding or adhering, to provide capillary channels on a surface of the sheet of material between portions of the one or more wires, wherein the channels are capable of transporting liquid across the surface of the sheet through capillary action.

Examples will now be further described with reference to figures in which:

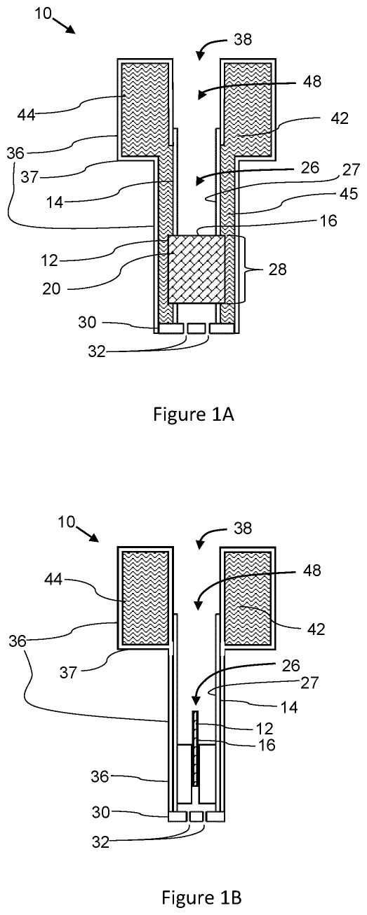

FIG. 1A shows a schematic illustration of a cartridge for an aerosol-generating system, the cartridge comprising a susceptor assembly;

FIG. 1B shows a schematic illustration of an alternative cross-section of the cartridge of FIG. 1A;

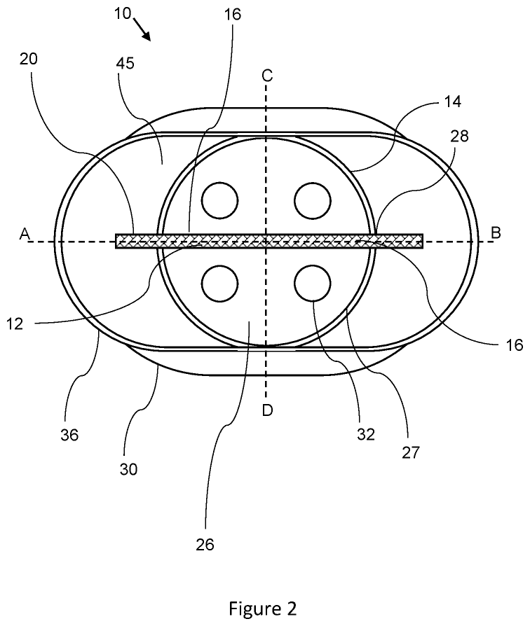

FIG. 2 shows a schematic illustration of a further alternative cross-section of the cartridge of FIGS. 1A and 1B;

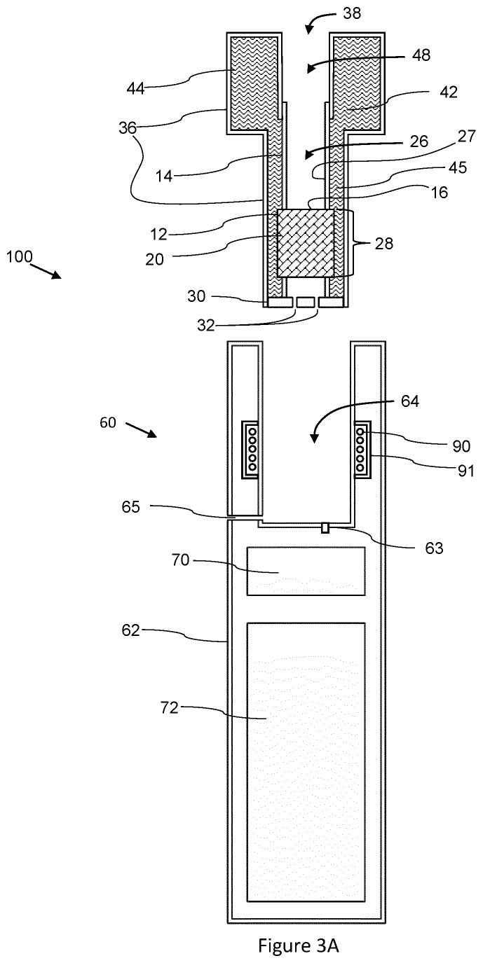

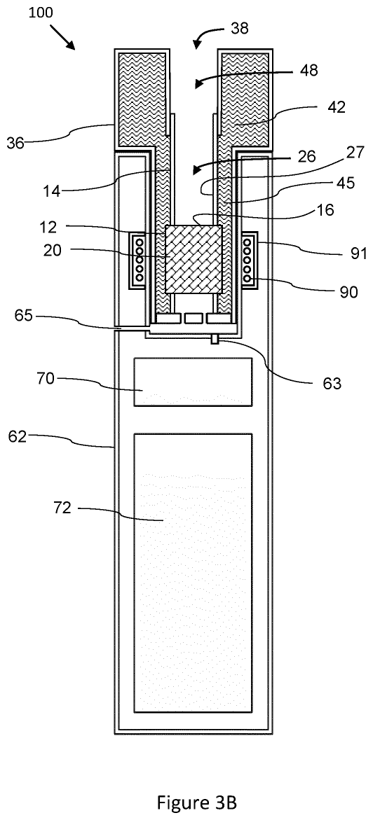

FIG. 3A shows a schematic illustration of an aerosol-generating system formed of a cartridge and an aerosol-generating device, in which the cartridge is decoupled from the aerosol-generating device;

FIG. 3B shows a schematic illustration of a cross-section of the aerosol-generating system of FIG. 3A, in which the cartridge is coupled to the aerosol-generating device.

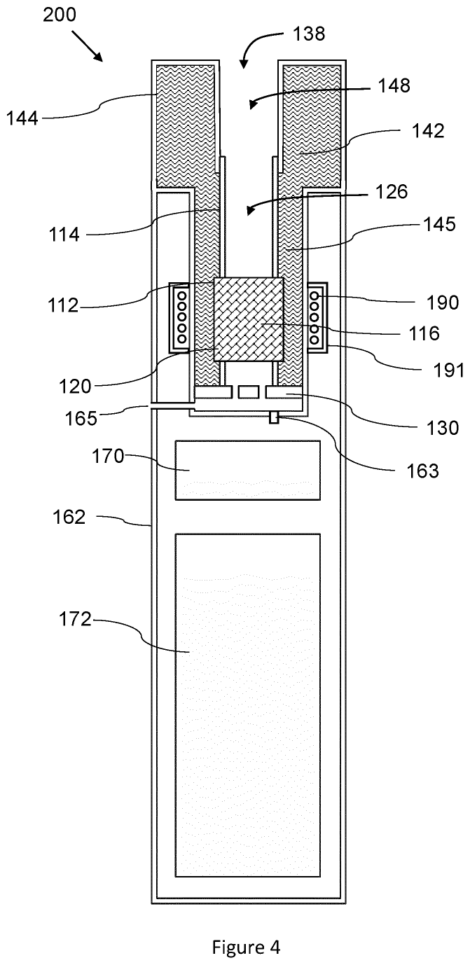

FIG. 4 shows a schematic illustration of a cross-section of an aerosol-generating system, the system comprising a susceptor assembly;

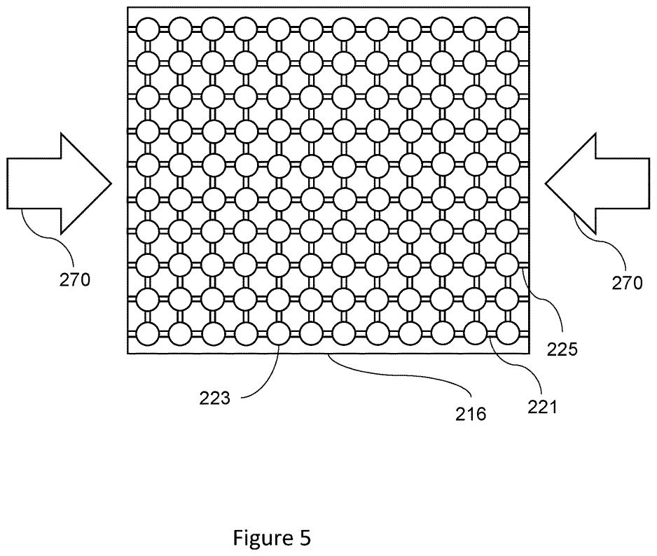

FIG. 5 shows a schematic illustration of an embodiment of a susceptor assembly according to the first aspect of the present disclosure.

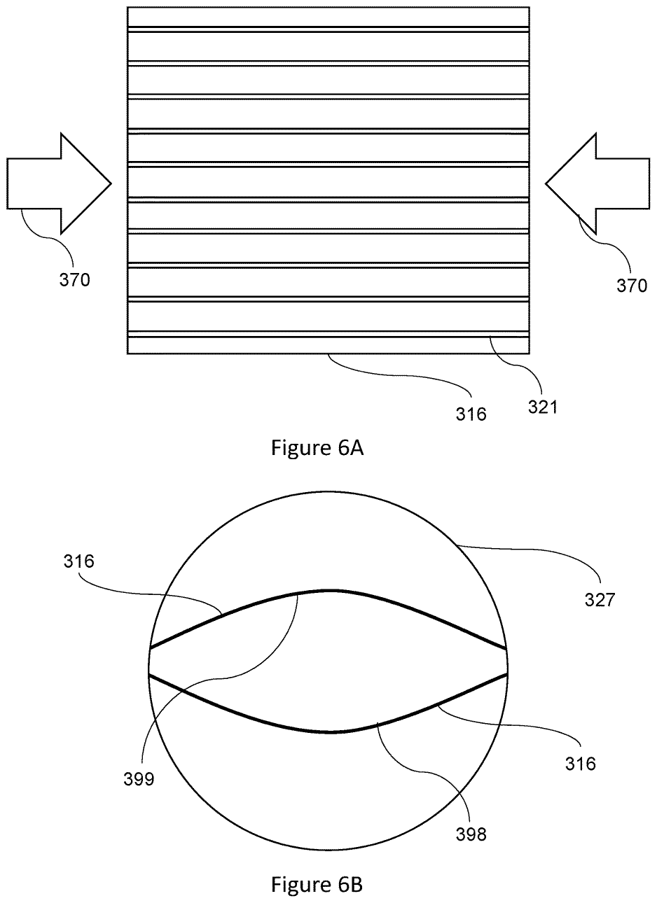

FIG. 6 shows a schematic illustration of a further embodiment of a susceptor assembly according to the first aspect of the present disclosure.

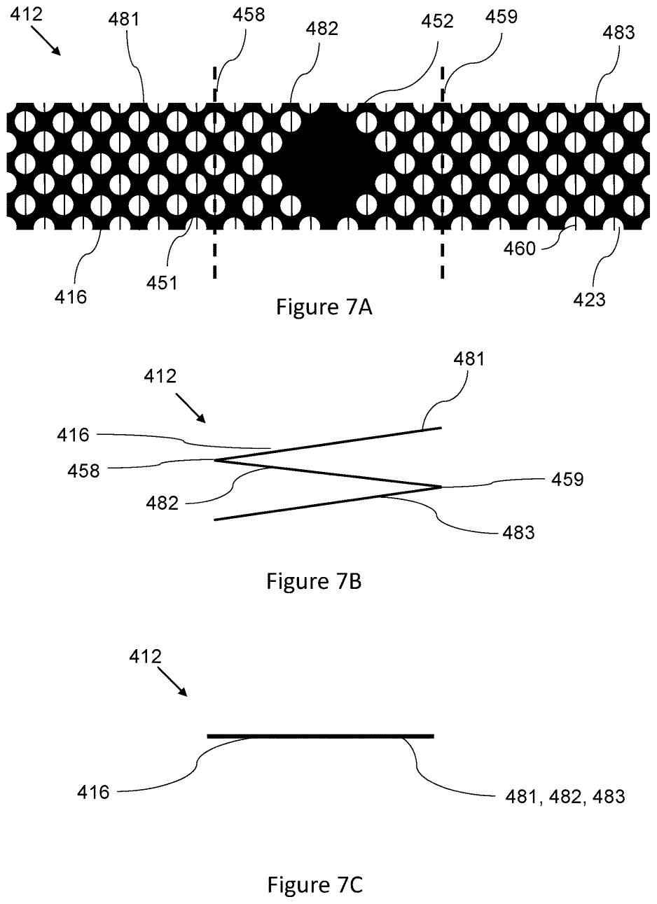

FIG. 7 shows a schematic illustration of an embodiment of a susceptor assembly, wherein the susceptor element is folded along fold lines to become a folded susceptor element with at least one layer.

FIGS. 1A and 1B show schematic illustrations of two cross sections of a cartridge 10 for an aerosol-generating system, the cartridge comprises a susceptor assembly according to a first embodiment of the present disclosure. The two cross sections are taken in two planes perpendicular to one another.

FIG. 1 shows the cartridge 10 comprising a susceptor holder 14 and a susceptor assembly 12 mounted in the susceptor holder 14. The susceptor assembly 12 in this embodiment is planar, and thin, having a thickness dimension that is substantially smaller than a length dimension and a width dimension. The susceptor assembly 12 is rectangular, and comprises a susceptor element 16. The outer, side portions 20 of the susceptor element 16 protrude through a pair of openings 28 arranged on opposed sides of an internal side wall 27 of the susceptor holder 14, into one of two channels 45. The internal side wall 27 defines an internal passage 26 of the susceptor holder 14. The susceptor element 16 comprises a non-woven sheet formed from ferritic stainless steel. The susceptor assembly 12 comprises a plurality of channels. The plurality of channels are configured to deliver liquid aerosol-forming substrate through capillary action across the surface of the susceptor element 16.

The susceptor element 16 is configured to be heatable by penetration with an alternating magnetic field, for vaporising an aerosol-forming substrate. The outer, side portions 20 of the susceptor element protrude through the pair of openings 28 in the susceptor holder 14, such that the susceptor holder 14 supports the susceptor assembly 12 in position in the cartridge 10.

The susceptor assembly 12 is partially arranged inside the internal passage 26 of the tubular susceptor holder 14, and extends in a plane parallel to a central longitudinal axis of the susceptor holder 14. The susceptor element 16 is arranged entirely within the internal passage 26 of the susceptor holder 14 and the outer, side portions 20 of the susceptor element 16 extend through the pair of openings 28 in the internal side wall 27 of the susceptor holder 14 into the two channels 45. The outer, side portions 20 of the susceptor element 16 define mounting regions of the susceptor assembly 12 for mounting the susceptor assembly in the susceptor holder 14.

The cartridge 10 has a mouth end and a connection end opposite to the mouth end. An outer housing 36 defines a mouth end opening 38 at the mouth end of the cartridge 10. The connection end is configured for connection of the cartridge 10 to an aerosol-generating device 60, as described in detail below. The susceptor assembly 12 and the susceptor holder 14 are located towards the connection end of the cartridge 10.

The outer housing 36 is formed from a mouldable plastics material, such as polypropylene. The outer housing 36 defines an internal space in which the susceptor assembly 12 and the susceptor holder 14 are contained.

The external width of the outer housing 36 is greater at the mouth end of the cartridge 10 than at the connection end, which are joined by a shoulder 37. This enables the connection end of the cartridge 10 to be received in a cavity of an aerosol-generating device 60, with the shoulder 37 locating the cartridge in the correct position in the aerosol-generating device 60. This also enables the mouth end of the cartridge 10 to remain outside of the aerosol-generating device 60, with the mouth end conforming to the external shape of the aerosol-generating device 60.

The cartridge 10 further comprises a liquid reservoir 44. The liquid reservoir 44 is defined in the cartridge 10 for holding a liquid aerosol-forming substrate 42.

The liquid reservoir 44 extends from the mouth end of the outer housing 36 to the connection end of the outer housing 36, and comprises an annular space defined by the outer housing 36 and an internal side wall of the cartridge 10.

The internal side wall of the cartridge 10 defines an internal passage 48 that extends between the mouth end opening 38, and an open end of the internal passage 26 of the susceptor holder 14.

The liquid reservoir 44 further comprises the two channels 45, the two channels 45 being defined between the outer housing 36 at the connection end and the internal side wall 27 defining the internal passage 26 of the susceptor holder 14. The two channels 45 extend from the annular space defined by the outer housing 36 and the internal side wall of the cartridge 10 at the mouth end of the cartridge 10, to the connection end of the cartridge 10. The outer, side portions 20 of the susceptor element 16 extend through the openings 28 in the internal side wall 27 of the susceptor holder 14 into the two channels 45. The two channels 45 extend from the annular space defined by the outer housing 36 and the internal side wall of the cartridge 10 at the mouth end of the cartridge 10, on opposite sides of the internal passage 26 of the susceptor holder 14.

The susceptor holder 14 comprises a base 30 that partially closes one end of the internal passage 26. The base 30 comprises a plurality of air inlets 32 that enable air to be drawn into the internal passage 26 through the partially closed end.

An air passage is formed through the cartridge 10 by the internal passage 26 of the susceptor holder 14, and internal passage 48. The air passage extends from the air inlets 32 in the base 30 of the susceptor holder 14, through the internal passage 26 of the susceptor holder 14, and through the internal passage 48 to the mouth end opening 38. The air passage enables air to be drawn through the cartridge 10 from the connection end to the mouth end.

FIG. 2 shows a schematic illustration of a further alternative cross section of the cartridge 10 of FIGS. 1A and 1B. The cartridge 10 is viewed perpendicular to the views shown in FIGS. 1A and 1B, such that the cross section shown in FIG. 1A is indicated by the dashed line AB, and the cross section shown in FIG. 1B is indicated by the dashed line CD.

The cartridge 10 comprises susceptor holder 14. The susceptor holder 14 comprises a tubular body formed from a mouldable plastic material, such as polypropylene. The tubular body of the susceptor holder 14 comprises the internal side wall 27 defining the internal passage 26 having open ends. The pair of openings 28 extend through the internal side wall 27, at opposite sides of the tubular susceptor holder 14. The openings 28 are arranged centrally along the length of the susceptor holder 14.

The pair of openings 28 in the side wall 27 of the susceptor holder 14 are sized to accommodate the susceptor assembly 12 with a friction fit, such that the susceptor assembly is secured in the susceptor holder 14. The friction fit between the susceptor assembly 12 and the susceptor holder 14 results in the mounting regions directly contacting the susceptor holder 14 at the openings 28. The susceptor assembly 12 and the susceptor holder 14 are secured together such that movement of the susceptor holder 14 also moves the susceptor assembly 12.

It will be appreciated that the susceptor assembly 12 and the susceptor holder 14 may be secured together by other means. For example, in some embodiments the susceptor assembly 12 is secured to the susceptor holder 14 by an adhesive at the mounting regions of the susceptor assembly 12, such that the mounting regions indirectly contact the susceptor holder 14.

The two channels 45 are positioned on opposite sides of the internal passage 26, and in use the two channels 45 supply liquid aerosol-forming substrate to the susceptor assembly 12. The outer, side portions 20 of the susceptor element 16 which form the mounting regions of the susceptor assembly 12 extend out of the internal passage 26 into the channels 45 via the openings 28. The channels 45 are shown empty in FIG. 2, but can be understood to be filled with liquid aerosol-forming substrate prior to use.

The cartridge 10 is viewed in FIG. 2 from the mouth end towards the connection end. The plurality of air inlets 32 in the base 30 can therefore be seen in FIG. 2.

FIG. 3A shows a schematic illustration of a cross-section of an aerosol-generating system 100 according to the present disclosure, with cartridge 10 decoupled from an aerosol generating device 60.

The cartridge 10 is identical to that presented in FIGS. 1a, 1b and 2, and their corresponding descriptions.

The aerosol-generating device 60 comprises a generally cylindrical device outer housing 62 having a connection end and a distal end opposite the connection end. A cavity 64 for receiving the connection end of the cartridge 10 is located at the connection end of the device 60, and an air inlet 65 is provided through the device outer housing 62 at the base of the cavity 64 to enable ambient air to be drawn into the cavity 64.

The aerosol-generating device 60 further comprises an inductive heating arrangement arranged within the device outer housing 62. The inductive heating arrangement includes an inductor coil 90, control circuitry 70 and a power supply 72. The power supply 72 comprises a rechargeable nickel cadmium battery or a lithium ion battery, which is rechargeable via an electrical connector (not shown) at the distal end of the device. The control circuitry 70 is connected to the power supply 72, and to the inductor coil 90, such that the control circuitry 70 controls the supply of power to the inductor coil 90. The control circuitry 70 is configured to supply an alternating current to the inductor coil 90.

The single inductor coil 90 is positioned around the susceptor assembly 12 when the cartridge 10 is received in the cavity 64. The inductor coil 90 has a size and a shape matching the size and shape of the susceptor element 16. The inductor coil 90 is made with a copper wire having a round circular section, and is arranged on a coil former element (not shown). The inductor coil 90 is both tubular and helical, and defines a circular cross section when viewed along the longitudinal axis of the aerosol-generating device 60.

The inductor coil 90 is configured such that when the alternating current is supplied to the inductor coil, the inductor coil generates an alternating magnetic field in the region of the susceptor assembly 12 when the cartridge 10 is received in the cavity 64.

The inductive heating arrangement further includes a flux concentrator element 91. The flux concentrator element 91 has a greater radius than the inductor coil 90, and so partially surrounds the inductor coil 90. The flux concentrator element 91 is configured to reduce stray power losses from the generated magnetic field.

FIG. 3B shows a schematic illustration of a cross section of the aerosol-generating system 100 of FIG. 3A, but with the cartridge 10 coupled to the aerosol-generating device 60.

In operation, when a user puffs on the mouth end opening 38 of the cartridge 10, ambient air is drawn into the base of the cavity 64 through air inlet 65, and into the cartridge 10 through the air inlets 32 in the base 30 of the cartridge 10. The ambient air flows through the cartridge 10 from the base 30 to the mouth end opening 38, through the air passage defined by internal passage 26 and over the susceptor assembly 12.

The control circuitry 70 controls the supply of electrical power from the power supply 72 to the inductor coil 90 when the system is activated.

The control circuitry 72 is coupled to an airflow sensor 63. The airflow sensor 63 is in fluid communication with the passage of ambient air which is drawn through the system by the user. The control circuitry 72 supplies electrical power to the inductor coil 90 when user-applied puffs on the cartridge 10 are detected by the airflow sensor 63.

When the system 100 is activated, an alternating current is established in the inductor coil 90, which generates alternating magnetic fields in the cavity 64 in which the susceptor assembly 12 is located, causing the susceptor element 16 to heat. Liquid aerosol-forming substrate in the liquid reservoir 44 is drawn into the susceptor assembly 12 through capillary action. The liquid aerosol-forming substrate 42 at the susceptor element 16 is heated, and volatile compounds from the heated aerosol-forming substrate are released into the air passage defined by the internal passage 48 of the cartridge 10, and cool to form an aerosol. The aerosol is entrained in the air being drawn through the internal passage 48 of the cartridge 10, and is drawn out of the cartridge 10 at the mouth end opening 38 for inhalation by the user.

FIG. 4 shows a schematic illustration of a cross-section of the aerosol-generating system 200, the system 200 comprising a susceptor assembly 112. As used herein, the words aerosol-generating system and system are used interchangeably.

In operation, when a user puffs on the mouth end opening 138 of the system, ambient air is drawn into the system 200 through an air inlet 165. The ambient air flows through the system 200 from the air inlet 165 to the mouth end opening 138, through the air passage defined by internal passage 126 and over the susceptor assembly 112.

The control circuitry 170 controls the supply of electrical power from the power supply 172 to the inductor coil 190 when the system is activated.

The control circuitry 172 is coupled to an airflow sensor 163. The airflow sensor 163 is in fluid communication with the passage of ambient air which is drawn through the system by the user. The control circuitry 172 supplies electrical power to the inductor coil 190 when user-applied puffs on the aerosol-generating system 200 are detected by the airflow sensor 163.

When the aerosol-generating system 200 is activated, an alternating current is established in the inductor coil 190, which generates an alternating magnetic field in the cavity 64 in which the susceptor assembly 112 is located, causing the susceptor element 116 to heat. Liquid aerosol-forming substrate in the liquid reservoir 144 is drawn into the susceptor assembly 112 through capillary action. The liquid aerosol-forming substrate 142 at the susceptor element 16 is heated, and volatile compounds from the heated aerosol-forming substrate are released into the air passage defined by the internal passage 148 of the aerosol-generating system 200, and cool to form an aerosol. The aerosol is entrained in the air being drawn through the internal passage 148 of the aerosol-generating system 200, and is drawn out of the internal passage 148 at the mouth end opening 138 for inhalation by the user.

The aerosol-generating system 200 comprises a generally cylindrical device outer housing 162 having a connection end and a distal end opposite the connection end. An air inlet 65 is provided through the device outer housing 62 at the base of the cavity 64 to enable ambient air to be drawn into the cavity 64.

The aerosol-generating system 200 further comprises an inductive heating arrangement arranged within the system outer housing 162. The inductive heating arrangement includes an inductor coil 190, control circuitry 170 and a power supply 172. The power supply 172 comprises a rechargeable nickel cadmium battery or a lithium ion battery, which is rechargeable via an electrical connector (not shown) at the distal end of the system. The control circuitry 170 is connected to the power supply 172, and to the inductor coil 190, such that the control circuitry 170 controls the supply of power to the inductor coil 190. The control circuitry 170 is configured to supply an alternating current to the inductor coil 190.

The single inductor coil 190 is positioned around the susceptor assembly 112 in the aerosol-generating system 200. The inductor coil 90 has a size and a shape matching the size and shape of the susceptor element 116. The inductor coil 190 is made with a copper wire having a round circular section, and is arranged on a coil former element (not shown). The inductor coil 190 is both tubular and helical, and defines a circular cross section when viewed along the longitudinal axis of the aerosol-generating system 200.

The inductor coil 190 is configured such that when the alternating current is supplied to the inductor coil, the inductor coil generates an alternating magnetic field in the region of the susceptor assembly 112.

The inductive heating arrangement further includes a flux concentrator element 191. The flux concentrator element 191 has a greater radius than the inductor coil 190, and so partially surrounds the inductor coil 190. The flux concentrator element 191 is configured to reduce stray power losses from the generated magnetic field.

FIG. 5 shows a schematic illustration of an embodiment of a susceptor assembly 212 according to the first aspect of the present disclosure. The susceptor element 216 is a non-woven sheet. In the embodiment shown in FIG. 5, the susceptor element has a flat rectangular shape. The susceptor assembly comprises a plurality of channels 221. The channels 221 are configured to exert a capillary force on the liquid aerosol-forming substrate, such that the channels 221 assist in transporting the liquid aerosol-forming substrate across the surface of the susceptor element 216. The channels in this embodiment have a depth that is less than the thickness of the susceptor element 216. Each channel is formed in the susceptor element by etching, for example chemical etching. In other embodiments, each channel may be formed by laser engraving, stamping or wire electrical discharge. The susceptor element 216 may be arranged in the same manner as the susceptor element 16, 116 in FIGS. 1A, 1B, 3A, 3B, and 4, wherein peripheral channels 225 are located on the side portions 20, 120 of the susceptor assembly so that they are in direct fluid communication with liquid aerosol-forming substrate located within the liquid reservoir 44. The proximal end of a peripheral channel 225 connects to an aperture 223 and the distal end extends into the liquid reservoir 44. The liquid feed 270 from the liquid reservoir 44 travels parallel to the direction in which the peripheral channels 225 extend before reaching an aperture 223.

The susceptor assembly in FIG. 5 further comprises a plurality of apertures 223. The apertures 223 extend from one surface of the susceptor element 216 to the opposite surface of the susceptor element 216. Each aperture 223 has the same cross-section, the cross-section of the apertures 223 in this embodiment is circular. The apertures 223 act as vaporisation sites for the liquid aerosol-forming substrate. The apertures 223 are connected to at least one channel 221. Each channel 221 of the plurality of channels 221 extend from one aperture 223 to a proximate aperture 223 to create a network of channels 221 and apertures 223 across the surface of the susceptor element 216. The network of channels 221 and apertures 223 extend cross the entire surface of the susceptor element. There may be alternative embodiments where the susceptor assembly comprises a first region that comprises neither channels 221 nor apertures 223 and a second region that comprises channels 221 and apertures 223.

FIG. 6A shows a schematic illustration of a further embodiment of a susceptor assembly according to the first aspect of the present disclosure, wherein the susceptor assembly comprises longitudinal channels 321. The susceptor element 312 is a non-woven sheet. In the embodiment shown in FIG. 6, the susceptor element has a flat rectangular shape. The longitudinal channels 321 are parallel to one another and all extend in the same direction of the liquid feed 370. Each longitudinal channel 321 extends across the full width of the susceptor; opposite ends of the longitudinal channels 321 extend to the edge of the susceptor element 312. The channels act in the same way as the channels 221 in FIG. 5, to transport the liquid aerosol-forming substrate across the face of the susceptor element 316. The longitudinal channels 321 act as vaporisation sites for the liquid aerosol-forming substrate.

The longitudinal channels 321 in FIG. 6A have a depth that is less than the thickness of the susceptor element 312. Each channel is formed by etching, for example chemical etching. In other embodiments, each channel may be formed by laser engraving, stamping or wire electrical discharge.

FIG. 6B shows a schematic illustration of another view of the embodiment in FIG. 6A., The susceptor element 316 has an eye-shaped cross section. The longitudinal channels 321 are located on the inside surface 399 and outside surface 398 of the eye-shaped susceptor element 316. The may be embodiments where the channels are only located on the inside surface 399 or the outside surface 398. The susceptor element 316 extends into openings in the the internal side wall 327, so that portions of the longitudinal channels are in fluid communication with the liquid reservoir,

FIG. 7A shows a schematic illustration of another embodiment of a susceptor assembly 412, wherein the susceptor element 416 is folded along fold lines to provide plural layers as shown in FIG. 7B. The susceptor assembly 412 in this embodiment comprises a first fold line 458 and a second fold line 459. The first fold line 458 joins the first layer 481 and the second layer 482. The second fold 459 line joins the second layer 482 and third layer 483. In other embodiments there may be more than two fold lines to provide more than three layers. The susceptor element 416 in FIG. 7 is a perforated foil strip. As used herein, the terms perforation and aperture are used interchangeably. The perforations in this embodiment are achieved by photo-chemical-etching (PCE). It will be appreciated that there may be other thin foil hole fabrication processes, for example; laser micro-machining/drilling and creation of an expanded metal sheet.

A plurality of wires 460 are wound around the susceptor element 416 in FIG. 7A so that they are parallel to one another and parallel to the direction of the liquid feed. The wires 460 comprise a magnetic material. The wires 460 comprise a ferritic stainless steel. The wires 460 contribute to inductive heat generation. The plurality of wires 460 acts as channels in this embodiment; small gaps created by the wires allow for capillary action. This capillary action transports the liquid aerosol-forming substrate across the surface of the susceptor element 416 in FIG. 7A. There may be embodiments where a single wire is wound around the susceptor element 416, the single wire may comprise a plurality of sections.

The susceptor assembly 412 comprises a first region 451 and a second region 452. The first region 451 comprises a first array of first apertures 423. The apertures 423 in the first region 451 are identical to each other. The apertures 423 in the first region 451 are arranged in a uniform pattern. There may be embodiments where the apertures 423 are arranged in a non-uniform pattern. The susceptor elements 716 further comprises a second region 752. The second region 752 comprises no apertures. The second region 752 has a lower density of apertures 423 than the first region 651, as there are no apertures in the second region 752. Heat conduction is greater in the second region because of the absence of apertures, reducing the chance of overheating in the second region. There may be embodiments where the second region comprises apertures 423. The first region 451 surrounds the second region 452. The apertures 423 in FIG. 7 are circular, but they may be a different shape for example; hexagonal, quadrilateral, triangular. If a hole fabrication process like an expanded metal mesh is used, the apertures may be quadrilateral.

FIG. 7B shows a schematic illustration of the susceptor assembly 412 shown in FIG. 7A from a side view as it is being folded. The susceptor element 416 in FIG. 7B has been folded along fold lines 458, 459. The partially folded susceptor element 416 in FIG. 7B comprises a first layer 481, a second layer 482 and a third layer 483, wherein the second layer 482 is located between the first layer 481 and third layer 483. The second region 482 shown in FIG. 7B is covered above and below by the first region 481. At the first fold line 458, the first layer 481 is folded above the second layer 482. At the second fold line 459 the third layer 483 is folded below the second layer 482.

FIG. 7C shows a schematic illustration of the susceptor assembly shown in FIGS. 7A and 7B where the susceptor element 416 is fully folded. The susceptor element 416 in FIG. 7C has been folded to the point where it is substantially flat. The first, second, and third layers 481, 482, 483 of the susceptor element 416 are substantially parallel in the horizontal plane in FIG. 7C.

1.-15. (canceled)

16. A susceptor assembly for an aerosol-generating system, the susceptor assembly comprising:
a susceptor element in the form of a sheet, and at least one channel formed on a surface of the sheet and configured to transport a liquid aerosol-forming substrate across the surface of the sheet; and
a plurality of wires or wire sections arranged on the surface of the susceptor element, the at least one channel being formed between one or more of the wires or the wire sections.

17. The susceptor assembly according to claim 16, further comprising a plurality of channels formed on the surface of the sheet and configured to transport the liquid aerosol-forming substrate across the surface of the sheet.

18. The susceptor assembly according to claim 17, wherein the plurality of channels are connected to one another.

19. The susceptor assembly according to claim 16, wherein the at least one channel extends from an edge of the susceptor element to a central region of the susceptor element.

20. The susceptor assembly according to claim 16, further comprising one or more apertures extending through the sheet from the surface to an opposite surface.

21. The susceptor assembly according to claim 20,
wherein the one or more apertures comprises a plurality of apertures, and
wherein the plurality of apertures have a size, shape, or arrangement in a first region of the sheet that is different from in a second region of the sheet.

22. The susceptor assembly according to claim 16, wherein the sheet is folded along at least one fold line to provide a plurality of layers of the susceptor element.

23. The susceptor assembly according to claim 22, wherein the sheet is folded so that the at least one channel is positioned on an internal surface of the susceptor assembly

24. A cartridge for an aerosol-generating system, the cartridge comprising:
the susceptor assembly according to claim 16; and
a liquid reservoir holding a liquid aerosol-forming substrate,
wherein the channels are in fluid communication with the liquid aerosol-forming substrate in the liquid reservoir and are arranged to transport the liquid aerosol-forming substrate across the surface of the susceptor element by capillary action.

25. The cartridge according to claim 24, further comprising:
an air inlet, an air outlet, and an airflow path extending from the air inlet, past the susceptor element to the air outlet; and
a susceptor holder that holds the susceptor assembly,
wherein at least a portion of the airflow path is defined by the susceptor holder.

26. The cartridge according to claim 25, wherein the susceptor holder retains the susceptor assembly so that at least a part of the susceptor element is positioned in the airflow path and such that the at least one channel is in fluid communication with the liquid aerosol-forming substrate in the liquid reservoir.

27. The cartridge according to claim 24, wherein the at least one channel extends from a periphery of the susceptor element positioned within the liquid reservoir to a central region of the susceptor element positioned in an airflow path through the cartridge.

28. An aerosol-generating system, comprising:
the cartridge according to claim 24; and
a main unit comprising:
an induction coil, and
a power supply connected to the inductor coil and configured to provide an alternating current to the inductor coil to generate an alternating magnetic field,
wherein the cartridge and the main unit are configured to connect with one another such that the susceptor assembly is positioned within the alternating magnetic field.

29. An aerosol-generating system, comprising:
the susceptor assembly according to claim 16;
a liquid reservoir holding a liquid aerosol-forming substrate, wherein the at least one channel is in fluid communication with the liquid aerosol-forming substrate in the liquid reservoir and is arranged to transport the liquid aerosol-forming substrate across the surface of the susceptor element by capillary action;
an induction coil; and
a power supply connected to the inductor coil and configured to provide an alternating current to the inductor coil to generate an alternating magnetic field,
wherein the susceptor assembly is positioned within the alternating magnetic field.

30. A method of manufacturing a susceptor assembly for an aerosol-generating device, the method comprising:
providing a sheet of material configured to be heatable through induction of eddy currents and hysteresis losses to vaporise an aerosol-forming substrate; and
providing one or more wires on or around the sheet of material, by winding or adhering, to provide capillary channels on a surface of the sheet of material between portions of the one or more wires,
wherein the channels are configured to transport liquid across the surface of the sheet through capillary action.
